(19) United States
(12) Patent Application Publication
(10) Pub. No.: US 2008/0160199 A1
(43) Pub. Date: Jul. 3, 2008

(54) HIGH PEROXIDE AUTODEPOSITION BATH

(76) Inventors: Manesh Nadupparambil Sekharan, Troy, MI (US); Bashir Ahmed, Rochester, MI (US); Omar Abu-Shanab, Auburn Hills, MI (US); William E. Fristad, Rochester Hills, MI (US); Brian J. Marvin, Warren, MI (US); Nicholas Herdzik, Sterling Heights, MI (US)

Correspondence Address: HENKEL CORPORATION, 1001 TROUT BROOK CROSSING, ROCKY HILL, CT, 06067, US

(21) Appl. No.: 11/948,725

(22) Filed: Nov. 30, 2007

Related U.S. Application Data
(60) Provisional application No. 60/868,200, filed on Dec. 1, 2006.

(51) Int. Cl. B05D 3/00; C08F 20/32

(52) U.S. Cl. 427/386; 427/372.2; 106/287.22

(57) ABSTRACT

This invention provides an autodeposition bath composition and process capable of coating zinciferous metal surfaces with minimal pinhole formation, comprising (a) at least one polymer, (b) at least one emulsifier, (c) optionally at least one cross-linker, (d) at least one accelerator component such as acid, oxidizing agent and/or complexing agents, (e) an average minimum concentration of H₂O₂ of at least 100 parts per million, (f) optionally, at least one filler and/or colorant, (g) optionally, at least one coalescing agent, and (h) water.

### CROSS-REFERENCE TO RELATED CASES

This application claims priority to U.S. Provisional Patent Application Ser. No. 60/868,200 filed Dec. 1, 2006, hereby incorporated herein by reference.

### FIELD OF THE INVENTION

This invention relates to an aqueous autodeposition composition and process of coating non-ferrous metal substrates using this composition which comprises a concentration of H₂O₂ of about 150-1000 parts per million. The composition is useful in manufacture of corrosion resistant autodeposition coated articles having metal surfaces that are more reactive to the autodeposition bath than ferrous metals. One benefit of the invention is a reduction in pinhole formation in autodeposited coatings applied to zinc and zinc-iron alloys, such as galvanized, surfaces.

### BACKGROUND OF THE INVENTION

Autodeposition coatings, which are adherent coatings formed on metal surfaces, comprise an organic polymer coating deposited by electroless chemical reaction of the coating bath with the metal surfaces. Autodeposition has been in commercial use on steel surfaces for about thirty years and is now well established for that use. For details, see for example, U.S. Pat. No. 3,592,699 (Steinbrecher et al.); U.S. Pat. Nos. 4,108,817 and 4,178,400 (both to Lochel); U.S. Pat. No. 4,180,603 (Howell. Jr.); U.S. Pat. Nos. 4,242,379 and 4,243,704 (both to Hall et al.); U.S. Pat. No. 4,289,826 (Howell, Jr.); and U.S. Pat. No. 5,342,694 (Ahmed) as well as U.S. Pat. No. 5,500,460 (Ahmed et al.). The disclosures of all of these patents are hereby incorporated by reference. Additional compositions and processes for depositing autodeposition coatings are described in U.S. Pat. Nos. 6,989,411; 6,645,633; 6,559,204; 6,096,806; and 5,300,323, incorporated herein by reference.

Autodeposition compositions are usually in the form of liquid, usually aqueous, solutions, emulsions or dispersions in which active metal surfaces of inserted objects are coated with an adherent resin or polymer film that increases in thickness the longer the metal object remains in the bath, even though the liquid is stable for a long time against spontaneous precipitation or flocculation of any resin or polymer, in the absence of contact with active metal. “Active metal” is defined as metal that is more active than hydrogen in the electromotive series, i.e., that spontaneously begins to dissolve at a substantial rate (with accompanying evolution of hydrogen gas) when introduced into the liquid solution, emulsion or dispersion. Frequently because of the metal surface activity difference in a typical acidic autodeposition bath, different metallic articles undergo dissolution or corrosion or etching at varying rates. Obtaining etching of highly active metals such as zinc, which is useful in forming autodeposition coating, without hydrogen evolution is quite difficult in a standard autodeposition bath having a conventional chemistry formulated to coat steel. The hydrogen evolution through the wet autodeposition coating produces pinhole defects in the coating

Typically, the working baths are acidic in nature, having pHs ranging from about 1 to about 4. Such compositions, and processes of forming a coating on a metal surface using such compositions, are commonly denoted in the art, and in this specification, as “autodeposition” or “autodepositing” compositions, dispersions, emulsions, suspensions, baths, solutions, processes, methods, or a like term.

In building typical autodeposition baths, the practitioner adds sufficient H₂O₂ to bring the bath to an initial desired redox potential, and periodic additions of H₂O₂ are made to adjust the redox potential are required. The prior art teaches that the amount of H₂O₂ to be added to freshly prepared working composition is at least 0.050 g/l and not more than 2.1 g/l. Use of peroxides, especially H₂O₂, in autodeposition baths in small amounts to maintain the redox potential at a particular level is a well-documented process. However, there is no teaching in the prior art of periodically measuring H₂O₂ concentration or adding sufficient H₂O₂ to the bath to keep a consistent baseline concentration, that is a minimum concentration, of H₂O₂ in the bath. It has been, up to now, understood by those knowledgeable in the autodeposition arts that the H₂O₂ is added specifically to maintain the redox potential, and the minimum concentration to be maintained for this purpose is less than 50 parts per million H₂O₂. No consistent minimum concentration of H₂O₂ has been maintained, nor sought to be monitored and adjusted in autodeposition baths.

Despite excellent qualities of autodeposited coatings on ferrous metals, a drawback has been pinhole formation in the coatings deposited on metal surfaces that are more reactive toward the coating bath than ferrous metal. Examples of such metals include zinc, such as hot-dip and electro-galvanized, zinc-iron alloys, and mixtures thereof, as well as steel coated with these metals, such as Galvanneal® (these metals shall hereinafter be referred to collectively as “zinciferous metals”) The chemical reaction that results in deposition of the organic film-forming resin or polymer on a metal surface produces hydrogen gas as a by-product. In ferrous metals, hydrogen is generally believed to evolve at a sufficiently low rate that pinholes do not form in the organic coating on the ferrous metal surface. In treating more reactive metal surfaces, such as the zinc-containing metal surfaces described herein and the like, hydrogen evolves at a higher rate and forms gaseous bubbles on the metal surface. These bubbles burst, releasing the hydrogen gas, and result in a pinhole defect in the autodeposition coating. One method of slowing hydrogen formation is to reduce the reaction rate, however, this method is not economical.

Pinholes are a particular problem when coating a composite article comprising, ferrous metal, such as by way of non-limiting example, cold rolled steel (CRS), in the same autodeposition bath as other, more active metal surfaces such as by way of non-limiting example, galvanized surfaces. When coating a composite article, the autodeposition bath desirably is sufficiently reactive toward the least reactive metal, e.g. steel, that the organic film forming resin or polymer deposits thereon. In these baths, the more reactive metal, e.g. a zinc-containing metal surface, evolves hydrogen gas during the autodeposition coating process and pinholes in the wet coating develop. Thus there is a need for an autodeposition composition and process for use on surfaces comprising non-ferrous metal which reduces pinhole formation in autodeposited coatings deposited thereon. There is also a need for an autodeposition composition and process for coating composite articles, comprising ferrous metal portions and non-ferrous or ferrous/non-ferrous alloy portions, which reduces pinhole formation in autodeposition coatings on the non-ferrous or ferrous/non-ferrous alloy portions while allowing reaction of the ferrous portion sufficient to form a satisfactory autodeposition coating.

### SUMMARY OF THE INVENTION

It is an object of the invention to meet the above-described needs and avoid at least some of the drawbacks of the prior art by providing an autodeposition composition comprising:

An autodeposition working bath is provided comprising:
(a) at least 1.0%, based on the whole composition, of a component of dissolved, dispersed, or both dissolved and dispersed film forming polymer molecules; desirably polymers and copolymers of acrylic, polyvinyl chloride, epoxy, polyurethane and mixtures thereof; preferably an epoxy-acrylic hybrid polymer.
(b) at least one emulsifier in sufficient quantity to emulsify any water insoluble part of any other component so that, in the autodepositing liquid composition, no separation or segregation of bulk phases that is perceptible with normal unaided human vision occurs during storage at 25° C. for at least 24 hours after preparation of the autodepositing liquid composition, in the absence of contact of the autodepositing liquid composition with any metal that reacts with the autodepositing liquid composition to produce therein dissolved metal cations with a charge of at least two;
(c) optionally, at least one cross-linker,
(d) at least one dissolved accelerator component selected from the group consisting of acids, oxidizing agents, and complexing agents that are not part of immediately previously recited components (A) or (B), this accelerator component being sufficient in strength and amount to impart to the total autodepositing liquid composition an oxidation-reduction potential that is at least 100 mV more oxidizing than a standard hydrogen electrode;
(e) optionally, at least one filler;
(f) optionally, at least one colorant,
(g) optionally, at least one coalescing agent, and
(h) water;
wherein the accelerator comprises H₂O₂ maintained at an average minimum concentration of from about 100 parts per million to about 1000 parts per million.

In one embodiment of the autodeposition working bath, the H₂O₂ is maintained in the bath at a concentration no greater than 800 parts per million. In another embodiment, the H₂O₂ is maintained in the bath at a concentration of about 150 to about 1000 parts per million, preferably about 250 to 800 parts per million.

It is an object of the invention to provide an autodeposition bath wherein the H₂O₂ is maintained at an average minimum concentration of at least 150 parts per million.

It is another object of the invention to provide an article of manufacture comprising: (a) a substrate comprising a zinciferous metal surface; and (b) a corrosion resistant layer deposited according to the process of the invention on said surface, the corrosion resistant layer being substantially free of pinholes.

It is another object of the invention to provide a process for reducing pinhole formation in autodeposition coatings on zinciferous metal surfaces comprising:
a) establishing a concentration of H₂O₂ of about 100 to about 1000 parts per million in an autodeposition bath comprising a component of dissolved, dispersed, or both dissolved and dispersed film forming polymer molecules H₂O₂ and a source of fluoride ions;
b) contacting a substrate having at least one zinciferous metal surface with said autodeposition bath at a pH of between about 1 and about 4, for a sufficient time and at a sufficient temperature to deposit an uncured autodeposition coating thereon;
c) rinsing with water;
d) optionally, contacting the uncured autodeposition coating with an alkaline or acidic rinse;
e) curing the uncured autodeposition coating; and
f) adding at least one supplemental amount of H₂O₂ to the autodeposition bath such that the autodeposition bath maintains a minimum concentration of 100 parts per million.

It is yet another object of the invention to provide a process for treating an article comprising a substrate having at least one zinciferous metal surface comprising:
a) contacting a substrate having at least one zinciferous metal surface with an autodeposition bath comprising:
   a. a concentration of H₂O₂ of at least 100 parts per million;
   b. at least 1.0%, based on the whole composition, of a component of dissolved, dispersed, or both dissolved and dispersed film forming polymer molecules and
   c. a source of fluoride ions;
   the pH of the autodeposition bath being between about 1 and about 4, for a sufficient time and at a sufficient temperature to deposit an uncured autodeposition coating thereon;
b) rinsing with water;
c) optionally, contacting the uncured autodeposition coating with an alkaline or acidic rinse;
d) curing the uncured autodeposition coating.

It is another object of the invention to provide a process comprising the additional step of maintaining the H₂O₂ concentration in the autodeposition bath during coating operations at a minimum concentration of 100 parts per million.

### DETAILED DESCRIPTION OF THE INVENTION

Due to consumption in the redox reaction, the H₂O₂ concentration in an ordinary working autodeposition bath does not have a consistent minimum concentration of greater than 50 parts per million (ppm), measured using a standard laboratory titration with potassium permanganate. That is, autodeposition baths known in the art have a concentration of H₂O₂ during coating operations that is on the average less than 50 parts per million, despite transitory increases when the redox potential is adjusted. Also, in conventional autodeposition working baths, no efforts are made to maintain a minimum concentration of H₂O₂ at a consistent level. At the H₂O₂ concentrations present during coating operations in conventional autodeposition baths, pinholes were found to form on autodeposition coatings deposited on zinc-containing metal surfaces.

Applicants discovered that increasing the addition of H₂O₂ to a sufficient level to maintain a selected minimum concentration of H₂O₂ greater than, independently in order of increasing preference 100, 150, 200, 250, 300, 325, 350, 375, 400, 425 parts per million in the working bath resulted in reduced pinhole formation in autodeposition coatings on zinc-containing metal surfaces. That is, maintaining a minimum concentration of H₂O₂ at the recited amounts during coating operations reduces pinhole formation on zinciferous metal surfaces, such as zinc and iron-zinc alloys.

In Applicants' invention, maintaining the H₂O₂ concentration in a working autodeposition bath at levels of about 150-1000 parts per million reduced or eliminated pinholes in the resulting coating on nonferrous metals. Without being bound by a single theory, it is believed that H₂O₂ depolarizes the more active metal surfaces of zinc, such as hot-dip and electro-galvanized, zinc alloys, and mixtures thereof, thereby reducing production of gaseous hydrogen bubbles at the metal-bath interface and preventing pinhole defects in the coating.

The amount of H₂O₂ to be added, and the consistent minimum concentration to be maintained, depends at least in part upon the type of metallic article to be coated in the autodeposition bath. Zinc and zinc coated steel, such as HDG, EG; aluminum surfaces coated with zinc, and the like, can be effectively treated to reduce pinholes over a wide range of H₂O₂ concentrations. Desirably, these zinc surfaces are treated in autodeposition baths comprising a consistent minimum concentration of H₂O₂ of about 150 to about 1000 parts per million, preferably, 250 to 800 parts per million, most preferably about 350 to about 750 parts per million. Steel coated with iron-zinc alloy, such as Galvanneal®, appears to be more subject to pinhole formation and are desirably treated in autodeposition coating baths comprising a consistent minimum concentration of at least 400 parts per million H₂O₂. Like zinc, these substrates can be processed in baths with H₂O₂ concentrations as high as 1000 parts per million, without adverse affect.

To avoid generation of pinholes in the autodeposition coating surface, the concentration of H₂O₂ in the autodeposition bath is monitored and adjusted on a regular basis to maintain a consistent minimum concentration. To determine the concentration of H₂O₂ present in an autodeposition bath, Applicants used the following titration method:
1. Pipette 20 ml sample of autodeposition bath into a 250 ml flask.
2. Add 20 ml of 5 M Sulfuric Acid and swirl.
3. Place the flask in 65° C. water bath and let the contents sit undisturbed for 5 minutes.
4. Remove the coagulated polymer.
5. Remove the flask from the water bath and allow cooling for a few minutes.
6. Titrate the sample with 0.042 N potassium permanganate from a graduated burette to the titration endpoint. The amount of KMnO₄ solution consumed is noted.

Under acidic conditions the following reaction occurs during titration:

5H₂O₂+2MnO₄+6H⁺→2Mn²⁺+5O₂+8H₂O

The known amount and concentration of the potassium permanganate solution, which is consumed by reaction with H₂O₂ according to the above equation, allows calculation of the amount of H₂O₂ present in the sample. In order to determine the amount of H₂O₂ in the sample, where Molarity of KMnO₄=Normality of KMnO₄/5, the following calculations were used:

H₂O₂=(KMnO₄ solution used)(2.5)(KMnO₄ solution molarity)(Molecular wt. of H₂O₂)(1000/sample volume).

In one embodiment, autodeposition baths useful for coating of ferrous metal and zinc-containing metal surfaces desirably have a H₂O₂ concentration of about 300 parts per million to about 800 parts per million, preferably about 350 to about 750 parts per million, most preferably about 450 to about 650 parts per million. These levels ensure the reduction of pinhole formation without adversely affecting the ferrous metal. The maintenance of higher concentrations of H₂O₂ in the autodeposition bath made it possible to coat galvanized substrates, especially Galvanneal®, simultaneously in the same bath with cold rolled steel. In this embodiment, H₂O₂ concentrations greater than about 800 parts per million tend to result in blotching of the coating on the ferrous metal.

Even though the present description of the use of H₂O₂ pertains only to autodeposition bath, it can be easily envisioned that this technique can be utilized in any metal treatment process where hydrogen evolution is a concern for the quality of the coating process.

Unlike H₂O₂, most of the other known depolarizers such as hydroxylamine and hydroxylamine sulfates are reducing agents as well as alkaline in nature. These features of other depolarizers prevented their usage in a typical autodeposition bath that is acidic and oxidizing in nature. H₂O₂ is non-toxic and can be used in acidic as well as alkaline solutions. The reduction in pinhole formation can also be achieved by the use of other depolarizers, such as m-nitrobenzene sulfonate salts, nitric acid and the like. However Applicants found that these depolarizing agents are less efficient in reducing pinholes at concentrations suitable for use in autodeposition baths. Concentrations of m-nitrobenzene sulfonate salts and nitric acid that are sufficient to adequately reduce pinhole formation resulted in poor corrosion performance of the autodeposition coated panels.

Use of H₂O₂ at the amounts described in this invention does not change the pH of the bulk solution of an autodeposition bath. This steady pH is important to the stability of the autodeposition bath.

Autodeposition baths that can be used with higher consistent minimum concentrations of H₂O₂ according to the invention include various water-based coatings for metallic surfaces that utilize dispersions of resins capable of forming a protective coating when cured. Commercially available autodeposition baths and processes are suitable for use with the higher H₂O₂ levels and can be readily practiced by one of skill in the art by reference to this description and the autodeposition literature cited herein. Desirably, the autodeposition bath comprises an organic component selected from film forming polymer molecules such as polymers and copolymers of acrylic, polyvinyl chloride, epoxy, polyurethane, phenol-formaldehyde condensation polymers, and mixtures thereof. Preferred polymers and copolymers are epoxy; acrylic; polyvinyl chloride, particularly internally stabilized polyvinyl chloride; and mixtures thereof; most preferably an epoxy-acrylic hybrid.

This invention provides an autodeposition bath composition comprising (a) at least one of the aforedescribed polymers, (b) at least one emulsifier, (c) optionally at least one cross-linker, (d) at least one accelerator component such as acid, oxidizing agent and/or complexing agents, (e) an average minimum concentration of H₂O₂ of at least 100 parts per million, (f) optionally, at least one filler and/or colorant, (g) optionally, at least one coalescing agent, and (h) water.

To prepare a bath composition suitable for coating a metallic substrate by autodeposition, at least one of the aforedescribed polymers in aqueous emulsion or dispersion is combined with an autodeposition accelerator component which is capable of causing the dissolution of active metals (e.g., iron and zinc) from the surface of the metallic substrate in contact with the bath composition. Preferably, the amount of accelerator present is sufficient to dissolve at least about 0.020 gram equivalent weight of metal ions per hour per square decimeter of contacted surface at a temperature of 20° C. Preferably, the accelerator(s) are utilized in a concentration effective to impart to the bath composition an oxidation-reduction potential that is at least 100 millivolts more oxidizing than a standard hydrogen electrode. Such accelerators are well-known in the autodeposition coating field and include, for example, substances such as an acid, oxidizing agent, and/or complexing agent capable of causing the dissolution of active metals from active metal surfaces in contact with an autodeposition composition. The autodeposition accelerator component may be chosen from the group consisting of hydrofluoric acid and its salts, fluosilicic acid and its salts, fluotitanic acid and its salts, ferric ions, acetic acid, phosphoric acid, sulfuric acid, nitric acid, peroxy acids, citric acid and its salts, and tartaric acid and its salts. More preferably, the accelerator comprises: (a) a total amount of fluoride ions of at least 0.4 g/L, (b) an amount of dissolved trivalent iron atoms that is at least 0.003 g/L, (c) a source of hydrogen ions in an amount sufficient to impart to the autodeposition composition a pH that is at least 1.6 and not more than about 5. Hydrofluoric acid is preferred as a source for both the fluoride ions as well as the proper pH. Ferric fluoride can supply both fluoride ions as well as dissolved trivalent iron. Accelerators comprised of HF and FeF₃ are especially preferred for use in the present invention.

In one embodiment, ferric cations, hydrofluoric acid, and H₂O₂ are all used to constitute the autodeposition accelerator component. In a working composition according to the invention, independently for each constituent: the concentration of ferric cations preferably is at least, with increasing preference in the order given, 0.5, 0.8 or 1.0 g/l and independently preferably is not more than, with increasing preference in the order given, 2.95, 2.90, 2.85, or 2.75 g/l; the concentration of fluorine in anions preferably is at least, with increasing preference in the order given, 0.5, 0.8, 1.0, 1.2, 1.4, 1.5, 1.55, or 1.60 g/l and independently is not more than, with increasing preference in the order given, 10, 7, 5, 4, or 3 g/l; and the amount of H₂O₂ added to the freshly prepared working composition is at least, with increasing preference in the order given, 0.05, 0.1, 0.2, 0.3, or 0.4 g/l and independently preferably is not more than, with increasing preference in the order given, 2.1, 1.8, 1.5, 1.2, 1.0, 0.9, or 0.8 g/l, with additions of H₂O₂ made thereafter such that a consistent minimum concentration, that is a consistent minimum concentration of at least 100 parts per million is achieved.

A dispersion or coating bath composition of the present invention may also contain a number of additional ingredients that are added before, during, or after the formation of the dispersion. Such additional ingredients include fillers, biocides, foam control agents, pigments and soluble colorants, and flow control or leveling agents. The compositions of these various components may be selected in accordance with the concentrations of corresponding components used in conventional epoxy resin-based autodeposition compositions, such as those described in U.S. Pat. Nos. 5,500,460, and 6,096,806.

Suitable flow control additives or leveling agents include, for example, the acrylic (polyacrylate) substances known in the coatings art, such as the products sold under the trademark MODAFLOW® by Solutia, as well as other leveling agents such as BYK-310 (from BYK-Chemie), PERENOL® F-60 (from Henkel), and FLUORAD® FC-430 (from 3M).

Pigments and soluble colorants may generally be selected for compositions according to this invention from materials established as satisfactory for similar uses. Examples of suitable materials include carbon black, phthalocyanine blue, phthalocyanine green, quinacridone red, hansa yellow, and/or benzidine yellow pigment, and the like.

The dispersions and coating compositions of the present invention can be applied in the conventional manner. For example, with respect to an autodeposition composition, ordinarily a metal surface is degreased and rinsed with water before applying the autodeposition composition. Conventional techniques for cleaning and degreasing the metal surface to be treated according to the invention can be used for the present invention. The rinsing with water can be performed by exposure to running water, but will ordinarily be performed by immersion for from 10 to 120 seconds, or preferably from 20 to 60 seconds, in water at ordinary ambient temperature.

Any method can be used for contacting a metal surface with the autodeposition composition of the present invention. Examples include immersion (e.g., dipping), spraying or roll coating, and the like. Immersion is usually preferred.

Also furnished by this invention is a method of coating the non-ferrous metal and/or ferrous/non-ferrous alloy metal surface of a substrate comprising the steps of contacting said substrate with the aforedescribed autodeposition bath composition for a sufficient time to cause the formation of a film of the dispersed adduct particles on the metal surface of the substrate, separating the substrate from contact with the autodeposition bath composition, rinsing the substrate, and heating the substrate to coalesce and cure the film of the dispersed adduct particles adhered to said metal surface.

Other than in the operating examples, or where otherwise indicated, all numbers expressing quantities of ingredients, reaction conditions, or defining ingredient parameters used herein are to be understood as modified in all instances by the term “about”. Unless otherwise indicated, all percentages are percent by weight.

The invention and its benefits may be further appreciated by consideration of the following, non-limiting, examples and comparison examples.

### EXAMPLES

### Example 1

An autodeposition bath was made up using AUTOPHORETIC® 915, commercially available from Henkel Corporation, according to the instructions provided in Technical Process Bulletin No. 237300, Revised: Sep. 7, 2006. The bath contained 6% solids. Panels of hot dip galvanized (HDG) were treated according to the procedure of Table 1, all trade name products used in this example are commercially available from Henkel Corporation.

TABLE 1
Processing

| Processing step | Time (min.) |
|---|---|
| Spray cleaned with Ridoline 212 (10%) at 130° F. | 2 |
| Tap water rinsed | 1 |
| DI water rinsed | 1 |
| Contacted with AUTOPHORETIC ® 915 Bath | 1.5 |
| Tap water rinsed | 1 |
| Contacted with E-2 Reaction Rinse | 1 |
| Flash dried at 54° C. | 6 |
| Oven cured at 185° C. | 40 |

Eighteen panels were run, without the addition of replenisher or activator to replace the chemicals consumed. The first panel processed in the unmodified autodeposition bath had a film build of about 1.2 mils (about 30 microns). H₂O₂ was added dropwise to the autodeposition bath every 4 panels to a selected concentration of H₂O₂. By panel number 18, the film build had dropped to about 0.55 mils (about 14 microns). Higher concentrations of H₂O₂ did not raise the oxidation-reduction potential (hereinafter referred to as ORP) as much as expected. The ORP was recorded after every 4 panels, H₂O₂ added, and ORP measured again. Sufficient H₂O₂ was added to keep the ORP at 400 or greater. The Lineguard® 101 meter was used measure the etch rate of the autodeposition bath. The meter reading was started at 130 uA and was 100 uA after 18 panels. No adverse effects were noted in the bath or panels attributable to the increasing H₂O₂ concentration.

### Example 2

A second autodeposition bath was built according to the procedure of Example 1 and adjusted according to Technical Process Bulletin No. 237300 until the Lineguard® 101 meter gave a reading of 120 uA.

Panels of Galvanneal® were treated according to the procedure of Table 1, in the absence of additional H₂O₂. The autodeposited coating on the panels had numerous small pinholes. 100 parts per million H₂O₂ was added to the bath and a second panel was treated. This procedure was repeated until a series of Galvanneal® panels had been treated in the bath, wherein the bath was modified before each panel was run, with the addition of 100 parts per million H₂O₂. With each addition of H₂O₂ to the bath, the amount of pinholing was reduced.

### Example 3

The effect of increasing the minimum concentration of H₂O₂ in the autodeposition bath on the etch rate was explored at a constant HF concentration of less than 1 g/l. An autodeposition bath was made using AQUENCE™ 930, commercially available from Henkel Corporation. 113.3 g of AQUENCE™ 930 Make-up was mixed with 25 g of Autophoretic® 300 Starter and 861.7 g of deionized water. Lineguard® 101 measurements were used to calculate the etch rate of the autodeposition solution in the bath after further additions of H₂O₂. This etch rate is recognized in the autodeposition industry as correlating to the tendency of autodeposited coatings to build on a metal having a particular activity. The results are shown in Table 2.

TABLE 2

| Cumulative amount of H₂O₂ | |
|---|---|
| (mL of 30 wt % solution), | Lineguard ® 101 (uA) ± 10 uA |
| 0 | 60 |
| 0.5 | 70 |
| 1 | 60 |
| 1.5 | 60 |
| 2 | 60 |

A second AQUENCE™ 930 bath was made with 113.3 g of AQUENCE™ 930 Make up, 25 g of Autophoretic® 300 starter and 861.7 g of deionized water. This time 2 ml of a 5 wt % solution of HF was added to the bath and Lineguard® 101 readings were taken. More H₂O₂ was incrementally added and Lineguard® 101 readings were tracked. Finally, an additional 1 ml of the HF solution was added and Lineguard® 101 readings were taken. The results are shown in Table 3.

TABLE 3

| Cumulative amount of | Cumulative amount of | |
|---|---|---|
| HF (mL of 5 wt % | H₂O₂ (mL of 30 wt % | Lineguard ® 101 |
| solution) | solution) | (uA) ± 10 uA |
| 2 | 0 | 130 |
| 2 | 0.5 | 140 |
| 2 | 1 | 160 |
| 2 | 1.5 | 160 |
| 2 | 2 | 150 |
| 3 | 2 | 190 |

Above a threshold HF concentration, it appears that the etch rate as measured by the Lineguard® 101 is a function of both free fluoride ion concentration and the concentration of H₂O₂.

### Example 4

Evaluation of autodeposition coating appearance as a function of Lineguard® 101 readings at constant H₂O₂ concentration was made. An AQUENCE™ 930 bath was made with 113.3 g of AQUENCE™ 930 Make up, 25 g of Autophoretic® 300 Starter and 861.7 g of deionized water. An amount of H₂O₂ selected for the experiment was added to the autodeposition bath. HF was added and Lineguard® 101 readings were taken until the reading selected for the experiment was achieved. Metal panels having various metal surfaces were contacted with the autodeposition bath according to the procedure of Table 1, except that the AQUENCE™ 930 bath was used in place of AUTOPHORETIC® 915 and the immersion time in the autodeposition bath was increased to 2 to 2.5 minutes. New panels were used for each reading.

Case I: Substrates included Galvanneal (HIA) and steel (CRS). The minimum concentration of H₂O₂ was maintained at 1.0 g/liter of a 30% H₂O₂ solution which resulted in 300 parts per million active H₂O₂ by addition of small mounts of H₂O₂ after each panel was coated, based on titrations of the amount of H₂O₂ present after the panel was removed from the bath. The appearance of the panels and the Lineguard® 101 readings are shown in Table 4.

TABLE 6

| Lineguard ® 101 (uA) ± 10 uA | Appearance |
|---|---|
| 80 | OK but streaks |
| 200 | good |
| 260 | good |
| 300 | good |
| 350 | OK but getting matte |
| 400 | OK more matte |
| 480 | rougher matte |
| 510 | roughest matte |

TABLE 4

| Lineguard ® 101 | H₂O₂ | | |
|---|---|---|---|
| (uA) ± 10 uA | (g/l) | HIA Appearance | CRS Appearance |
| 60 | 1.0 | Good | Blotchy-half of panel is |
| | | | coated |
| 80 | 1.0 | Good | Smooth, slightly blotchy |
| | | | near edge |
| 100 | 1.0 | Good | Good and smooth |
| 110 | 1.0 | Good | Good, slight surface |
| | | | roughness |
| 120 | 1.0 | Good | Good, some surface |
| | | | roughness |
| 130 | 1.0 | Very fine | Good, some surface |
| | | micropinholes | roughness |
| 140 | 1.0 | Multiple | Good, some surface |
| | | micropinholes | roughness |
| | | and bumps | |
| 160 | 1.0 | Large pinholes | Good, some surface |
| | | covering entire | roughness |
| | | panel | |

Case II: The testing procedure from Case I was repeated at 10 uA increments with the following changes: substrates were Electrogalvanized (EG), Hot Dip Galvanized (HDG) and steel (CRS). The minimum concentration of H₂O₂ was maintained at 0.5 g/liter of a 30% H₂O₂ solution which resulted in 150 parts per million active H₂O₂. The Lineguard® 101 readings providing acceptable appearance of the various panels are shown in Table 5.

TABLE 5

| | Operating Range Lineguard ® |
|---|---|
| Substrate | 101 (uA) ± 10 uA |
| CRS | 70-450 |
| EG | 70-420 |
| HDG | 70-450 |

Case III: The testing procedure from Case I was repeated with the following changes: the substrate was Galvanneal (HIA), and the minimum concentration of H₂O₂ was maintained at 3.0 g/liter of a 30% H₂O₂ solution which resulted in 900 parts per million active H₂O₂. Various amounts of HF were added to achieve the Lineguard® 101 readings and the resulting appearance of the panels shown in Table 6.

1. A process for treating an article comprising a substrate having at least one zinciferous metal surface comprising:
g) contacting a substrate having at least one zinciferous metal surface with an autodeposition bath comprising:
a. a concentration of H₂O₂ of at least 100 parts per million;
b. at least 1.0%, based on the whole composition, of a component of dissolved, dispersed, or both dissolved and dispersed film forming polymer molecules and
c. a source of fluoride ions;
the pH of the autodeposition bath being between about 1 and about 4, for a sufficient time and at a sufficient temperature to deposit an uncured autodeposition coating thereon;
h) rinsing with water;
i) optionally, contacting the uncured autodeposition coating with an alkaline or acidic rinse;
j) curing the uncured autodeposition coating.

2. The process of claim 1, comprising the additional step of maintaining the H₂O₂ concentration in the autodeposition bath during coating operations at a minimum concentration of 100 parts per million.

3. The process of claim 2, wherein the H₂O₂ is maintained in the bath at a concentration of about 150 to about 1000 parts per million.

4. The process of claim 2, wherein the H₂O₂ is maintained in the bath at a concentration of about 250 to 800 parts per million.

5. The process of claim 1, wherein the substrate further comprises at least one ferrous metal surface.

6. The process of claim 2, wherein the H₂O₂ is maintained in the bath at a concentration of at least 400 parts per million and the substrate is a composite article comprising at least two different metal surfaces selected from an iron-zinc alloy and zinc.

7. The process of claim 1, wherein the film forming polymer molecules are selected from polymers and copolymers of acrylic, polyvinyl chloride, epoxy, polyurethane, phenol-formaldehyde condensation polymers, epoxy-acrylic hybrid polymer and mixtures thereof.

8. The process of claim 1, wherein the film forming polymer molecules comprise an epoxy-acrylic hybrid polymer.

9. An autodeposition working bath comprising:
(a) at least 1.0%, based on the whole composition, of a component of dissolved, dispersed, or both dissolved and dispersed film forming polymer molecules;
(b) at least one emulsifier in sufficient quantity to emulsify any water insoluble part of any other component so that, in the autodepositing liquid composition, no separation or segregation of bulk phases that is perceptible with normal unaided human vision occurs during storage at 25° C. for at least 24 hours after preparation of the autodepositing liquid composition, in the absence of contact of the autodepositing liquid composition with any metal that reacts with the autodepositing liquid composition to produce therein dissolved metal cations with a charge of at least two;
(c) optionally, at least one cross-linker,
(d) at least one dissolved accelerator component selected from the group consisting of acids, oxidizing agents, and complexing agents that are not part of immediately previously recited components (A) or (B), this accelerator component being sufficient in strength and amount to impart to the total autodepositing liquid composition an oxidation-reduction potential that is at least 100 mV more oxidizing than a standard hydrogen electrode;
(e) optionally, at least one filler;
(f) optionally, at least one colorant,
(g) optionally, at least one coalescing agent, and
(h) water;
wherein the accelerator comprises H₂O₂ maintained at an average minimum concentration of from about 100 parts per million to about 1000 parts per million.

10. The autodeposition working bath of claim 9, wherein the H₂O₂ is maintained in the bath at a concentration no greater than 800 parts per million.

11. The autodeposition working bath of claim 9, wherein the H₂O₂ is maintained in the bath at a concentration of about 150 to about 1000 parts per million.

12. The autodeposition working bath of claim 9, wherein the H₂O₂ is maintained in the bath at a concentration of about 250 to 800 parts per million.

13. The autodeposition working bath of claim 9, wherein the H₂O₂ maintained at an average minimum concentration of at least 150 parts per million.

14. The autodeposition working bath of claim 13, wherein the film forming polymer molecules are selected from polymers and copolymers of acrylic, polyvinyl chloride, epoxy, polyurethane and mixtures thereof.

15. The process of claim 13, wherein the film forming polymer molecules comprise an epoxy-acrylic hybrid polymer.

16. An article of manufacture comprising: (a) a substrate comprising a zinciferous metal surface; and (b) a corrosion resistant layer deposited according to the process of claim 1 on said surface, the corrosion resistant layer being substantially free of pinholes.

17. A process for reducing pinhole formation in autodeposition coatings on zinciferous metal surfaces comprising:
e) establishing a concentration of H₂O₂ of about 100 to about 1000 parts per million in an autodeposition bath comprising a component of dissolved, dispersed, or both dissolved and dispersed film forming polymer molecules H₂O₂ and a source of fluoride ions;
f) contacting a substrate having at least one zinciferous metal surface with said autodeposition bath at a pH of between about 1 and about 4, for a sufficient time and at a sufficient temperature to deposit an uncured autodeposition coating thereon;
g) rinsing with water;
h) optionally, contacting the uncured autodeposition coating with an alkaline or acidic rinse;
i) curing the uncured autodeposition coating; and
j) adding at least one supplemental amount of H₂O₂ to the autodeposition bath such that the autodeposition bath maintains a minimum concentration of 100 parts per million.
